(19) United States
(12) Patent Application Publication
(10) Pub. No.: US 2017/0115796 A1
(43) Pub. Date: Apr. 27, 2017

(54) METHOD, DEVICE AND TERMINAL APPARATUS FOR RECOGNIZING A MULTI-FINGER PINCHING-IN OR PINCHING-OUT GESTURE

(71) Applicant: Leauto Intelligent Technology (BEIJING) Co. Ltd., Beijing (CN)

(72) Inventor: Yang JIANG, Beijing (CN)

(21) Appl. No.: 14/978,979

(22) Filed: Dec. 22, 2015

(30) Foreign Application Priority Data
Oct. 23, 2015 (CN) 201510696379.9

(51) Int. Cl. G06F 3/041

(52) U.S. Cl. CPC G06F 3/0416; G06F 2203/04104

(57) ABSTRACT

The present disclosure provides a method, device, and terminal apparatus for recognizing a multi-finger pinching-in or pinching-out gesture. The method includes detecting a plurality of touch events on a touch screen by a user, and acquiring touch event data corresponding to each touch event, the touch event data including coordinates of a plurality of touch points and the time period of the touch event; calculating an average sliding rate of each touch point and a value of reduced or increased distance between any two of the touch points based on the touch event data; and determining that the user's gesture is a multi-finger pinching-in or pinching-out gesture, if average sliding rate of each touch point is greater than or equal to a preset sliding rate and the value of reduced or increased distance between any two of the touch points is greater than or equal to a preset value of distance variation.

### CROSS-REFERENCE TO RELATED APPLICATIONS

This application is based on and claims priority to Chinese Patent Application No. 201510696379.9, filed on Oct. 23, 2015, the full disclosure of which is hereby incorporated by reference in its entirety.

### TECHNICAL FIELD

The present disclosure relates to the field of terminal technology, and more particularly to a method, device, and terminal apparatus for recognizing a multi-finger pinching-in or pinching-out gesture.

### BACKGROUND

Right now, touch screen is widely used for various kinds of terminal apparatus (for example, mobile phone, tablet, navigator), and the general gestures applied to touch screen terminal apparatuses are the main intermediary for implementing human-computer interaction. For example, the single click gesture is used to open or close application programs, long pressing gesture is used for dragging some icon, and sliding gesture is used for unlocking apparatus, finding contacts, and so on.

As the functions of touch screen terminal apparatus and the application environment are diversified, the current general gestures cannot meet the needs of users.

For example, in vehicle-machine environment, the driver may feel difficult and unsafe in operation such as closing frequently operated applications such as voicing by making single click on a small icon during driving. However, the current touch screen terminal apparatuses support multi-point touch, but do not provide a recognizing solution with respect to a multi-finger pinching-in or pinching-out gesture.

### SUMMARY

The embodiments of the present disclosure provide a method, device, and terminal apparatus for recognizing a multi-finger pinching-in or pinching-out gesture, which may implement recognizing of gestures for pinching in or out multi-finger so as to meet the needs of the users.

To achieve the above technical objects, the embodiments of the present disclosure provide the following technical solutions:

In the first aspect, the embodiment of the present disclosure provides a method for recognizing a multi-finger pinching-in or pinching-out gesture, including: detecting a plurality of touch events on a touch screen by a user, and acquiring touch event data corresponding to each touch event, the touch event data including coordinates of a plurality of touch point and the time period of the touch event; calculating an average sliding rate of each touch point and a value of reduced or increased distance between any two of the touch points based on the touch event data; and determining that the user's gesture is a multi-finger pinching-in or pinching-out gesture, if the average sliding rate of each touch point is greater than or equal to a preset sliding rate and the value of reduced or increased distance between any two of the touch points is greater than or equal to a preset value of distance variation.

In the second aspect, the embodiment of the present disclosure provides a device for recognizing a multi-finger pinching-in or pinching-out gesture, including: a detecting module configured to detect a plurality of touch events on a touch screen by a user, and acquires touch event data corresponding to each touch event, the touch event data includes coordinates of a plurality of touch points and the time period of the touch event; a calculating module configured to calculate an average sliding rate of each touched point and a value of reduced or increased distance between any two of the touch points based on the touch event data; a determining module configured to determine that the user's gesture is a multi-finger pinching-in or pinching-out gesture, if the average sliding rate of each touch point is greater than or equal to a preset sliding rate and the value of reduced or increased distance between any two of the touch points is greater than or equal to a preset value of distance variation.

In the third aspect, the embodiment of the present disclosure provide a device for recognizing a multi-finger pinching-in or pinching-out gesture, comprising: one or more processors; a memory; and one or more programs stored in the memory and configured to perform operations when executed by the one or more processors, wherein the operations comprises: detecting a plurality of touch events on a touch screen by a user, and acquiring touch event data corresponding to each touch event, the touch event data comprising coordinates of a plurality of touch points and time period of the touch event; calculating an average sliding rate of each touch point and a value of reduced or increased distance between any two of the touch points based on the touch event data; and determining that the user's gesture is a multi-finger pinching-in or pinching-out gesture, if the average sliding rate of each touch point is greater than or equal to a preset sliding rate and the value of reduced or increased distance between any two of the touch points is greater than or equal to a preset value of distance variation.

In the fourth aspect, the embodiment of the present disclosure provides a terminal apparatus including the device for recognizing a multi-finger pinching-in or pinching-out gesture as described above.

The method, device, and terminal apparatus for recognizing a multi-finger pinching-in or pinching-out gesture provided by the present disclosure may implement recognizing of gestures for pinching in or out multi-finger so as to meet the needs of the users by detecting a plurality of touch events on a touch screen by a user, and calculating an average sliding rate of each touch point and a value of reduced or increased distance between any two of the touch points based on acquired touch event data corresponding to each touch event; determining that the user's gesture is a multi-finger pinching-in or pinching-out gesture, if average sliding rate of each touch point is greater than or equal to a preset sliding rate and the value of reduced or increased distance between any two of the touch points is greater than or equal to a preset value of distance variation.

### BRIEF DESCRIPTION OF THE DRAWINGS

FIG. 1 is a flowchart illustrating an embodiment of a method for recognizing a multi-finger pinching-in or pinching-out gesture provided by the present disclosure;

FIG. 2 is a flowchart illustrating another embodiment of the method for recognizing a multi-finger pinching-in or pinching-out gesture provided by the present disclosure;

FIG. 3 is a schematic diagram of storing touch event data upon happening of a first touch event;

FIG. 4 is a schematic diagram of storing touch event data upon happening of a second touch event;

FIG. 5 is a schematic diagram of storing touch event data upon happening of a fifth touch event;

FIG. 6 is a structural diagram of an embodiment of a device for recognizing a multi-finger pinching-in or pinching-out gesture provided by the present disclosure;

FIG. 7 is a structural diagram of another embodiment of a device for recognizing a multi-finger pinching-in or pinching-out gesture provided by the present disclosure;

FIG. 8 is a structural diagram of another embodiment of the device for recognizing a multi-finger pinching-in or pinching-out gesture provided by the present disclosure; and

FIG. 9 is a structural diagram of an embodiment of the terminal apparatus provided by the present disclosure.

### DESCRIPTION OF THE EMBODIMENTS

In the following, description will be given in detail on the method, device, and terminal apparatus for recognizing a multi-finger pinching-in or pinching-out gesture provided by the present disclosure, in connection with the accompanying drawing.

### First Embodiment

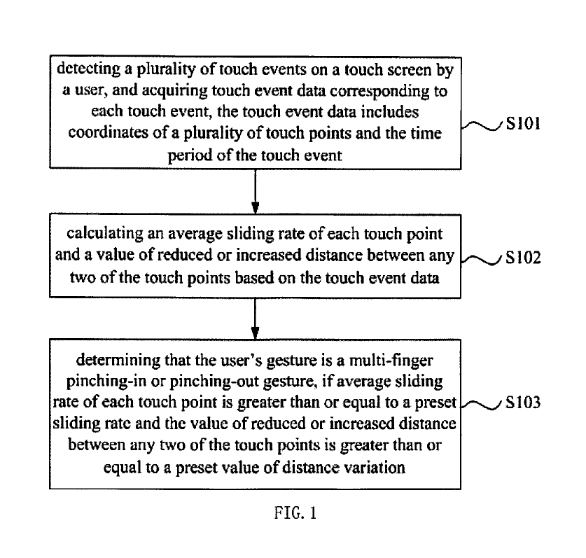

FIG. 1 is a flowchart illustrating an embodiment of the method for recognizing a multi-finger pinching-in or pinching-out gesture provided by the present disclosure. The method for recognizing a multi-finger pinching-in or pinching-out gesture of the embodiment of the present disclosure may be applicable to various kinds of touch screen terminal apparatuses (for example, mobile phone, tablet, navigator). As shown in FIG. 1, the method for recognizing a multi-finger pinching-in or pinching-out gesture of the embodiment of the present disclosure includes:

S101: detecting a plurality of touch events on a touch screen by a user, and acquiring touch event data corresponding to each touch event, the touch event data includes coordinates of a plurality of touch points and the time period of the touch event.

More particularly, when the user performs multi-finger pinching-in or pinching-out (for example, put five fingers together), the terminal apparatus detects the occurrence of touch event according to the sliding track on the touch screen made by the user, periodically acquires touch event data corresponding to each touch event (including coordinates of a plurality of touch points and the time period of the touch event). According to the experiments, in a general procedure of multi-finger pinching-in or pinching out, a terminal apparatus may detect occurrences of 5-15 touch events, which correspond to 5-15 groups of touch event data. The coordinates of a touch point are X-axis coordinate and Y-axis coordinate of the touch point on the touch screen.

S102: calculating an average sliding rate of each touch point and a value of reduced or increased distance between any two of the touch points based on the touch event data.

More particularly, the calculating of the average sliding rate of each touch point and a value of reduced or increased distance between any two of the touch points based on the touch event data includes: calculating distance between any two of the touch points based on the touch event data; calculating a value of reduced or increased distance between any two of the touch points based on the distance between any two of the touch points.

More particularly, for example, an average sliding rate of a touch point may be calculated by dividing the difference of coordinates of the touch points in two touch events by the difference of the time of the two touch events. The average sliding rates of other touch points may be calculated with similar methods. For example, based on coordinates (x1, y1), (x2, y2) of some two touch points in some touch event, a distance with respect to these two touch points in this touch event may be calculated as s=((x1−x2)2+(y1−y2)2)1/2. Based on distance in some touch event and distance in another touch event with respect to some two touch points, a value of reduced or increased distance between these two touch points may be calculated. The value of reduced or increased distance between other two touch points may be calculated by similar ways.

S103: determining that the user's gesture is a multi-finger pinching-in or pinching-out gesture, if average sliding rate of each touch point is greater than or equal to a preset sliding rate and the value of reduced or increased distance between any two of the touch points is greater than or equal to a preset value of distance variation.

More particularly, according to experiments, in a general procedure of multi-finger pinching-in or pinching out, an average sliding rate is about 1.7 pixel/millisecond, sliding distance of a touch point is about 85 pixels, and a value of reduced or increased distance between any two of the touch points is about 8 pixels, therefore a preset sliding rate may be set as 1.7 pixel/millisecond and a preset value of distance variation may be set as 8 pixels. It is apparent to one skilled in the art that the preset sliding rate may be set as other value in a range of 1.5˜2.0 pixel/millisecond, and the preset value of distance variation may be set as other value in a range of 6˜10 pixels. It can be determined that an event of multi-finger pinching-in (corresponding to the value of reduced distance) or pinching-out (corresponding to the value of increased distance) occurs, that is, the user's gesture is a multi-finger pinching-in or pinching-out gesture, if average sliding rates of a plurality of touch points are all greater than or equal to a preset sliding rate and the values of reduced or increased distance between two touch points among a plurality of touch points are all greater than or equal to a preset value of distance variation.

The method for recognizing a multi-finger pinching-in or pinching-out gesture of the present disclosure may implement recognizing of gestures for pinching in or out multi-finger so as to meet the needs of the users by detecting a plurality of touch events on a touch screen by a user, and calculating an average sliding rate of each touch point and a value of reduced or increased distance between any two of the touch points based on acquired touch event data corresponding to each touch event; determining that the user's gesture is a multi-finger pinching-in or pinching-out gesture, if average sliding rate of each touch point is greater than or equal to a preset sliding rate and the value of reduced or increased distance between any two of the touch points is greater than or equal to a preset value of distance variation.

### Second Embodiment

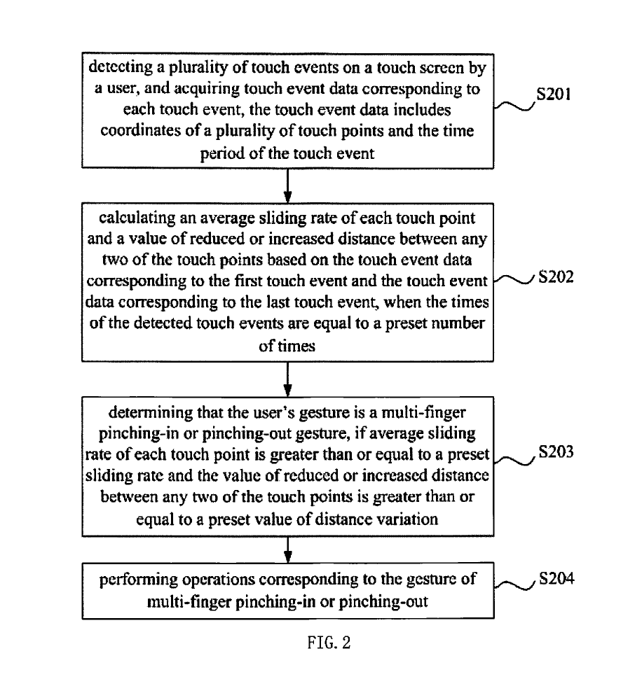

FIG. 2 is a flowchart illustrating another embodiment of the method for recognizing a multi-finger pinching-in or pinching-out gesture provided by the present disclosure. The method for recognizing a multi-finger pinching-in or pinching-out gesture of the embodiment of the present disclosure may be applicable to various kinds of touch screen terminal apparatuses (for example, mobile phone, tablet, navigator). As shown in FIG. 2, the method for recognizing a multi-finger pinching-in or pinching-out gesture of the embodiment of the present disclosure is another feasible implementation of the method for recognizing a multi-finger pinching-in or pinching-out gesture as shown in FIG. 1, and particularly includes:

S201: detecting a plurality of touch events on a touch screen by a user, and acquiring touch event data corresponding to each touch event, the touch event data includes coordinates of a plurality of touch points and the time period of the touch event.

More particularly, the description of detailed procedure of the step S201 can be referred to the description of Step S101 in the embodiment shown in FIG. 1, and thus may be omitted to avoid redundancy.

S202: calculating an average sliding rate of each touch point and a value of reduced or increased distance between any two of the touch points based on the touch event data corresponding to the first touch event and the touch event data corresponding to the last touch event, when the times of the detected touch events are equal to a preset number of times.

More particularly, according to the experiments, in a general procedure of multi-finger pinching-in or pinching out, a terminal apparatus may detect occurrences of 5-15 touch events and thus the preset number of times may be set as 5. It is apparent that the preset number of times may also be set as other value in a range of 5-15. It should be noted that the preset number of times should not be set too small so as to avoid misjudgment due to sliding over short distance. When the times of detected touch events is equal to the preset number of times, such as 5, the average sliding rate of some touch point may be calculated by dividing the difference of coordinates of this touch point in the first touch event and the fifth touch event by the difference of time of these two touch events. The value of reduced or increased distance between these two touch points may be calculated based on distances of these two touch points in the first and fifth touch events.

S203: determining that the user's gesture is a multi-finger pinching-in or pinching-out gesture, if average sliding rate of each touch point is greater than or equal to a preset sliding rate and the value of reduced or increased distance between any two of the touch points is greater than or equal to a preset value of distance variation.

More particularly, the description of detailed procedure of the step S203 is similar with the description of Step S103 in the embodiment shown in FIG. 1, and thus may be omitted to avoid redundancy.

Furthermore, after the step S203, the method for recognizing a multi-finger pinching-in or pinching-out gesture of the embodiment of the present disclosure may further include:

S204: performing operations corresponding to the gesture of multi-finger pinching-in or pinching-out.

More particularly, if it is determined that the user's current gesture is the gesture of multi-finger pinching-in or pinching-out, an operation corresponding to the gesture of multi-finger pinching-in or pinching-out, such as closing application, may be performed so as to meet the user's needs.

Furthermore, before the step S202, the method for recognizing a multi-finger pinching-in or pinching-out gesture of the embodiment of the present disclosure may further include: storing the touch event data in array sequentially in order, wherein the length of the array may be equal to the preset number of times.

More particularly, array is a set in which elements of the same data type is arranged in certain order, so as to store data. The terminal apparatus may package the touch event data into a Finger X Y Data Box object to be stored in array. The length of the array may not be to long; otherwise the time-space complexity for running program may be increased. The length of array may be defined as 5.

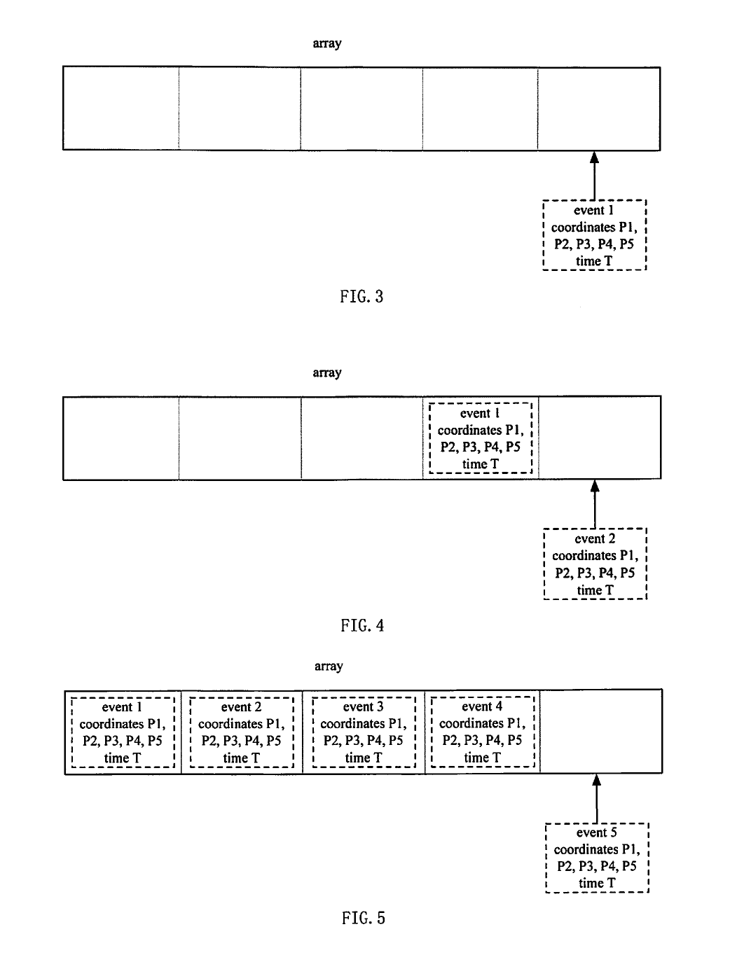

Assuming that the length of array is 5 and five fingers are pinched-in as an example, the dynamic flow of the touch event data when being stored in the array is shown in FIG. 3˜FIG. 5. More particularly, FIG. 3 is a schematic diagram of storing touch event data upon happening of a first touch event, FIG. 4 is a schematic diagram of storing touch event data upon happening of a second touch event, and FIG. 5 is a schematic diagram of storing touch event data upon happening of a fifth touch event. As shown in FIG. 3˜FIG. 5, when the first touch event (event 1) occurs, the corresponding touch event data (coordinates of five touch points: P1, P2, P3, P4, and P5, and the time of the first touch event: T) may be stored in the array as the fifth element; when the second touch event (event 2) occurs, the touch event data corresponding to the first touch event is left-shifted as the fourth element in the array, the touch event data corresponding to the second touch event (coordinates of five touch points: P1, P2, P3, P4, and P5, and the time of the second touch event: T) may be stored in the array as the fifth element; being continued likewise, when the fifth touch event (event 5) occurs, the touch event data corresponding to the first touch event is left-shifted as the first element in the array, the touch event data corresponding to the fifth touch event (coordinates of five touch points: P1, P2, P3, P4, and P5, and the time of the second touch event: T) may be stored in the array as the fifth element, and then the array is full for storage.

Furthermore, step S202 may particularly includes: calculating an average sliding rate of each touch point and a value of reduced or increased distance between any two of the touch points based on the touch event data corresponding to the first touch event and the touch event data corresponding to the last touch event, when the array is full for storage.

More particularly, when the array is not full for storage, that is, the first element in the array is null, the calculation may not be performed, so as to avoid the misjudgment due to sliding over too short distance.

Furthermore, after the step S203, the method for recognizing a multi-finger pinching-in or pinching-out gesture of the embodiment of the present disclosure may further include: emptying the array to avoid determining the occurrence of multi-finger pinching-in or pinching-out multi-times in single multi-finger pinching-in or pinching-out event. It is unnecessary to empty the array after a complete multi-finger pinching-in or pinching-out event. When there is new touch event data inserted into the array, the condition for determining multi-finger pinching-in or pinching-out would not be met immediately upon touching, since the time interval would be large.

The method for recognizing a multi-finger pinching-in or pinching-out gesture of the embodiment of the present disclosure may be implemented based on the touch event callback frame and broadcasting mechanism of Android system. In the system after Android 5.0, all touch events may be distributed to foreground applications in the ViewRootImpl.java class, the current touch event may be obtained in ViewRootImpl.java, and the Android system uses MotionEvent.java class to describe the touch event.

More particularly, the variables obtainable by the Android system are as follows: 1. notice event MotionEvent.ACTION_MOVE may be obtained when single-finger or multi-finger pinching-in or pinching-out; 2. the total number of touch points on the current screen may be obtained by MotionEvent.GetPointerCount( ); 3. the X-axis coordinate and Y-axis coordinate of the “i”th touch point by MotionEvent.GetX(i), MotionEvent.GetY(i).

More particularly, the touch variables obtained in experiments are as follows: 1. in a general procedure of multi-finger pinching-in or pinching out, the system may return 5-15 touch events; 2. in a general procedure of multi-finger pinching-in or pinching out, the average sliding rate is about 1.7 pixel/millisecond (based on Gaxlaxy Note 8.0 tablet from Samsung); 3. in a general procedure of multi-finger pinching-in or pinching out, the sliding distance of a touch point is about 85 pixels; 4. in a general procedure of multi-finger pinching-in or pinching out, the value of reduced or increased distance between any two of the touch points is about 8 pixels.

The method for recognizing a multi-finger pinching-in or pinching-out gesture of the present disclosure may implement recognizing of gestures for pinching in or out multi-finger so as to meet the needs of the users by detecting a plurality of touch events on a touch screen by a user, and calculating an average sliding rate of each touch point and a value of reduced or increased distance between any two of the touch points based on acquired touch event data corresponding to each touch event; determining that the user's gesture is a multi-finger pinching-in or pinching-out gesture, if average sliding rate of each touch point is greater than or equal to a preset sliding rate and the value of reduced or increased distance between any two of the touch points is greater than or equal to a preset value of distance variation.

### Third Embodiment

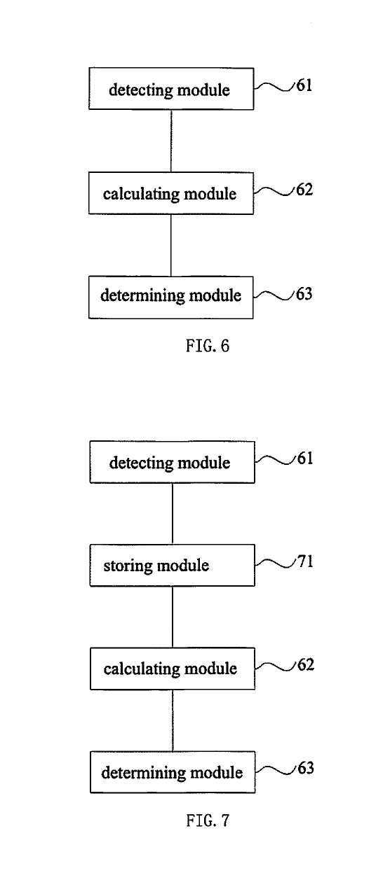

FIG. 6 is a structural diagram of an embodiment of the device for recognizing a multi-finger pinching-in or pinching-out gesture provided by the present disclosure. The device for recognizing a multi-finger pinching-in or pinching-out gesture of the embodiment of the present disclosure may be installed in various kinds of touch screen terminal apparatuses (for example, mobile phone, tablet, navigator) to implement the method for recognizing a multi-finger pinching-in or pinching-out gesture of the embodiment as shown in FIG. 1. As shown in FIG. 6, the device for recognizing a multi-finger pinching-in or pinching-out gesture provided by the present disclosure may include: a detecting module 61, a calculation module 62, and a determining module 63.

The detecting module 61 is configured to detect a plurality of touch events on a touch screen by a user, and acquires touch event data corresponding to each touch event, the touch event data including coordinates of a plurality of touch points and the time period of the touch event.

The calculating module 62 is configured to calculate an average sliding rate of each touch point and a value of reduced or increased distance between any two of the touch points based on the touch event data.

The determining module 63 is configured to determine that the user's gesture is a multi-finger pinching-in or pinching-out gesture, if average sliding rate of each touch point is greater than or equal to a preset sliding rate and the value of reduced or increased distance between any two of the touch points is greater than or equal to a preset value of distance variation.

More particularly, the description of procedures for respective modules of the device for recognizing a multi-finger pinching-in or pinching-out gesture provided by the embodiment of the present disclosure to implement their functions can be referred to the description in the embodiment of the method shown in FIG. 1, and thus may be omitted to avoid redundancy.

The device for recognizing a multi-finger pinching-in or pinching-out gesture of the present disclosure may implement recognizing of gestures for pinching in or out multi-finger so as to meet the needs of the users by detecting a plurality of touch events on a touch screen by a user, and calculating an average sliding rate of each touch point and a value of reduced or increased distance between any two of the touch points based on acquired touch event data corresponding to each touch event; and determining that the user's gesture is a multi-finger pinching-in or pinching-out gesture, if average sliding rate of each touch point is greater than or equal to a preset sliding rate and the value of reduced or increased distance between any two of the touch points is greater than or equal to a preset value of distance variation.

### Fourth Embodiment

FIG. 7 is a structural diagram of another embodiment of the device for recognizing a multi-finger pinching-in or pinching-out gesture provided by the present disclosure. The device for recognizing a multi-finger pinching-in or pinching-out gesture of the embodiment of the present disclosure may be installed in various kinds of touch screen terminal apparatus (for example, mobile phone, tablet, navigator) to implement the method for recognizing a multi-finger pinching-in or pinching-out gesture of the embodiment as shown in FIG. 2. As shown in FIG. 7, based on the embodiment shown in FIG. 6, the calculating module 62 of the device for recognizing a multi-finger pinching-in or pinching-out gesture provided by the present disclosure may be further configured to:

calculate an average sliding rate of each touch point and a value of reduced or increased distance between any two of the touch points based on the touch event data corresponding to the first touch event and the touch event data corresponding to the last touch event, when the times of the detected touch events are equal to a preset number of times.

More particularly, the calculating module 62 is particularly configured to: calculate distance between any two of the touch points based on touch event data; calculate the value of reduced or increased distance between any two of the touch points based on the distance between any two of the touch points.

More particularly, the device for recognizing a multi-finger pinching-in or pinching-out gesture provided by the present disclosure may further include a storing module 71 configured to store the touch event data in array sequentially in order, wherein the length of the array may be equal to the preset number of times.

More particularly, the calculating module 62 may be configured to calculate an average sliding rate of each touch point and a value of reduced or increased distance between any two of the touch points based on the touch event data corresponding to the first touch event and the touch event data corresponding to the last touch event, when the array is full for storage.

More particularly, the determining module 62 may be further configured to empty the array when it is determined that the user's gesture is a multi-finger pinching-in or pinching-out gesture.

More particularly, the average sliding rate may be set as 1.7 pixel/millisecond, the coordinates may include X-axis coordinate and Y-axis coordinate, the preset value of distance variation may be 8 pixels, and the preset number of times may be 5.

Furthermore, the determining module 63 may be further configured to perform operations corresponding to the gesture of multi-finger pinching-in or pinching-out when it is determined that the user's gesture is a multi-finger pinching-in or pinching-out gesture.

More particularly, the description of procedures for respective modules of the device for recognizing a multi-finger pinching-in or pinching-out gesture provided by the embodiment of the present disclosure to implement their functions can be referred to the description in the embodiment of the method shown in FIG. 2, and thus may be omitted to avoid redundancy.

The device for recognizing a multi-finger pinching-in or pinching-out gesture of the present disclosure may implement recognizing of gestures for pinching in or out multi-finger so as to meet the needs of the users by detecting a plurality of touch events on a touch screen by a user, and calculating an average sliding rate of each touch point and a value of reduced or increased distance between any two of the touch points based on acquired touch event data corresponding to each touch event; and determining that the user's gesture is a multi-finger pinching-in or pinching-out gesture, if average sliding rate of each touch point is greater than or equal to a preset sliding rate and the value of reduced or increased distance between any two of the touch points is greater than or equal to a preset value of distance variation.

### Fifth Embodiment

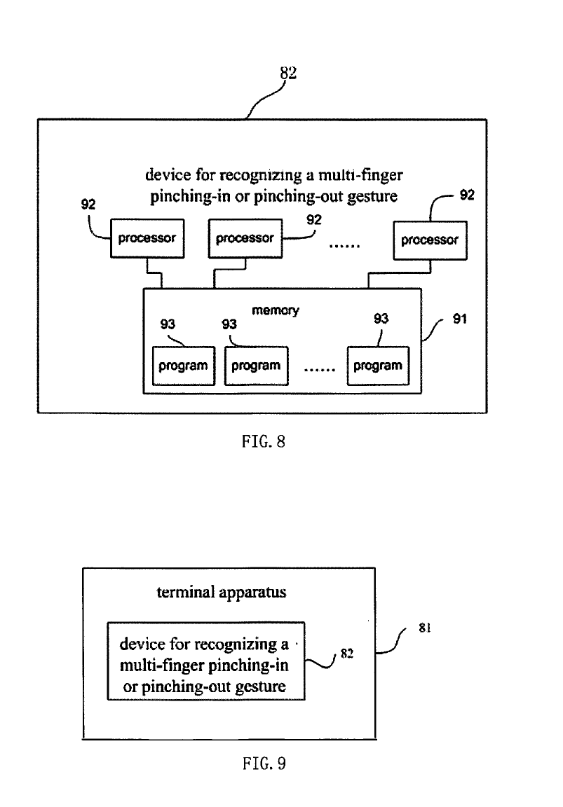

FIG. 9 is a structural diagram of an embodiment of the terminal apparatus provided by the present disclosure. The terminal apparatus of the embodiment of the present disclosure may be various kinds of touch screen terminal apparatuses (for example, mobile phone, tablet, navigator) and may implement the method for recognizing a multi-finger pinching-in or pinching-out gesture of the embodiment as shown in FIG. 1 or FIG. 2. As shown in FIG. 9, the terminal apparatus 81 of the embodiment of the present disclosure may include the device for recognizing a multi-finger pinching-in or pinching-out gesture 82 of the embodiment as shown in FIG. 6 or FIG. 7 or FIG. 8.

More particularly, the description of procedures for the device for recognizing a multi-finger pinching-in or pinching-out gesture 82 in the terminal apparatus 81 of the embodiment of the present disclosure to implement their functions can be referred to the description in the embodiment of the method shown in FIG. 1 or FIG. 2, and thus may be omitted to avoid redundancy.

The terminal apparatus of embodiment of the present disclosure may implement recognizing of gestures for pinching in or out multi-finger so as to meet the needs of the users by detecting a plurality of touch events on a touch screen by a user, and calculating an average sliding rate of each touch point and a value of reduced or increased distance between any two of the touch points based on acquired touch event data corresponding to each touch event; determining that the user's gesture is a multi-finger pinching-in or pinching-out gesture, if average sliding rate of each touch point is greater than or equal to a preset sliding rate and the value of reduced or increased distance between any two of the touch points is greater than or equal to a preset value of distance variation.

One skilled in the art would appreciate that all or a part of the steps for implementing the foregoing method embodiments may be implemented by hardware related to program instructions. Foregoing programs may be stored in computer-readable storage medium, and upon being executed, such programs may perform the steps including foregoing method embodiments; and examples of foregoing storage medium include ROM, RAM, CD-ROM, a magnetic tape, the other types of storage mediums which may store the program codes.

It should be noted that the foregoing embodiments are merely used to illustrate the technical solution of the present disclosure, and not to limit the present disclosure. Although the present disclosure has been described in detail with reference to the foregoing embodiments, one skilled in the art would understand that the technical solutions recited in the foregoing embodiments may be modified or all or a part of the technical features may be replaced equally. These modifications and replacements are not intended to make corresponding technical solution depart from the scope of the technical solution of embodiments of the present disclosure.

What is claimed is:

1. A method for recognizing a multi-finger pinching-in or pinching-out gesture, comprising:
detecting a plurality of touch events on a touch screen by a user, and acquiring touch event data corresponding to each touch event, the touch event data comprising coordinates of a plurality of touch points and a time period of the touch event;
calculating an average sliding rate of each touch point and a value of a reduced or increased distance between any two of the touch points based on the touch event data; and
determining that a user's gesture is a multi-finger pinching-in or pinching-out gesture, when the average sliding rate of each touch point is greater than or equal to a preset sliding rate and the value of the reduced or increased distance between any two of the touch points is greater than or equal to a preset value of distance variation.

2. The method for recognizing a multi-finger pinching-in or pinching-out gesture according to claim 1, wherein the calculating an average sliding rate of each touch point and a value of reduced or increased distance between any two of the touch points based on the touch event data comprises:
calculating an average sliding rate of each touch point and a value of reduced or increased distance between any two of the touch points based on the touch event data corresponding to a first touch event and the touch event data corresponding to a last touch event, when the times of the detected touch events are equal to a preset number of times.

3. The method for recognizing a multi-finger pinching-in or pinching-out gesture according to claim 1, wherein the calculating the value of the reduced or increased distance between any two of the touch points based on the touch event data comprises:
calculating a distance between any two of the touch points based on the touch event data; and
calculating a value of the reduced or increased distance between any two of the touch points based on the distance between any two of the touch points.

4. The method for recognizing a multi-finger pinching-in or pinching-out gesture according to claim 2, further comprising: sequentially storing the touch event data in an array in order, wherein the length of the array is equal to the preset number of times, and
the detected number of times of the touch events being equal to the preset number of times is the case that the array is full for storage.

5. The method for recognizing a multi-finger pinching-in or pinching-out gesture according to claim 4, further comprising: after determining that the user's gesture is a multi-finger pinching-in or pinching-out gesture
emptying the array.

6. The method for recognizing multi-finger pinching-in or pinching-out gesture according to claim 1, further comprising: after determining that the user's gesture is a multi-finger pinching-in or pinching-out gesture,
performing operations corresponding to the multi-finger pinching-in or pinching-out gesture.

7. A device for recognizing a multi-finger pinching-in or pinching-out gesture, comprising:
one or more processors;
a memory; and
one or more programs stored in the memory and configured to perform operations when executed by the one or more processors, wherein the operations comprises:
detecting a plurality of touch events on a touch screen by a user, and acquiring touch event data corresponding to each touch event, the touch event data comprising coordinates of a plurality of touch points and a time period of the touch event;
calculating an average sliding rate of each touch point and a value of a reduced or increased distance between any two of the touch points based on the touch event data; and
determining that a user's gesture is a multi-finger pinching-in or pinching-out gesture, when the average sliding rate of each touch point is greater than or equal to a preset sliding rate and the value of a reduced or increased distance between any two of the touch points is greater than or equal to a preset value of distance variation.

8. The device for recognizing a multi-finger pinching-in or pinching-out gesture according to claim 7, wherein the calculating an average sliding rate of each touch point and a value of a reduced or increased distance between any two of the touch points based on the touch event data further comprises:
calculating an average sliding rate of each touch point and a value of the reduced or increased distance between any two of the touch points based on the touch event data corresponding to a first touch event and the touch event data corresponding to a last touch event, when the times of the detected touch events are equal to a preset number of times.

9. The device for recognizing a multi-finger pinching-in or pinching-out gesture according to claim 7, wherein the calculating an average sliding rate of each touch point and a value of a reduced or increased distance between any two of the touch points based on the touch event data further comprises:
calculating distance between any two of the touch points based on the touch event data; and
calculating a value of the reduced or increased distance between any two of the touch points based on a distance between any two of the touch points.

10. The device for recognizing a multi-finger pinching-in or pinching-out gesture according to claim 8, wherein the calculating an average sliding rate of each touch point and a value of reduced or increased distance between any two of the touch points based on the touch event data further comprises:
calculating distance between any two of the touch points based on the touch event data; and
calculating a value of the reduced or increased distance between any two of the touch points based on a distance between any two of the touch points.

11. The device for recognizing a multi-finger pinching-in or pinching-out gesture according to claim 7, wherein the operations further comprise:
storing the touch event data in an array sequentially in order, wherein the length of the array is equal to the preset number of times, and
the calculating an average sliding rate of each touch point and a value of reduced or increased distance between any two of the touch points based on the touch event data further comprises calculating an average sliding rate of each touch point and a value of reduced or increased distance between any two of the touch points based on touch event data corresponding to a first touch event and touch event data corresponding to a last touch event when the array is full for storage.

12. The device for recognizing a multi-finger pinching-in or pinching-out gesture according to claim 11, wherein the determining that the user's gesture is a multi-finger pinching-in or pinching-out gesture further comprises:
emptying the array after determining that the user's gesture is a multi-finger pinching-in or pinching-out gesture.

13. The device for recognizing a multi-finger pinching-in or pinching-out gesture according to claim 7, the determining that the user's gesture is a multi-finger pinching-in or pinching-out gesture further comprises:
performing operations corresponding to the multi-finger pinching-in or pinching-out gesture after determining that the user's gesture is a multi-finger pinching-in or pinching-out gesture.
